(19) United States
(12) Patent Application Publication
(10) Pub. No.: US 2018/0174058 A1
(43) Pub. Date: Jun. 21, 2018

(54) PROVIDING DYNAMIC AND PERSONALIZED RECOMMENDATIONS

(71) Applicant: HCL Technologies Limited, Chennai (IN)

(72) Inventors: Gaurav Vrati, Noida (IN); Nidhi Ghildyal, Noida (IN); Sanjay Yadav, Sunnyvale, CA (US)

(73) Assignee: HCL Technologies Limited, Chennai (IN)

(21) Appl. No.: 14/260,300

(22) Filed: Apr. 24, 2014

(51) Int. Cl. G06N 5/04; G06F 17/30; G06Q 30/02

(52) U.S. Cl. CPC G06N 5/04; G06Q 30/0261; G06F 17/30241

(57) ABSTRACT

Providing dynamic and personalized recommendations. Disclosed herein is a method and system for providing dynamic and personalized recommendations to a user, when the user is driving; wherein the recommendations are based on at least one of social data, predictive analytics, vehicle location and vehicle speed.

### TECHNICAL FIELD

Embodiments disclosed herein relate to geo-location based applications and more particularly to providing dynamic and personalized recommendations to a user, when the user is driving; wherein the recommendations are based on at least one of social data, predictive analytics, vehicle location and vehicle speed.

### BACKGROUND

Users may use a variety of devices such as mobile phones, dedicated devices, tablets and so on to avail Geographic Information System (GIS) services. These GIS services may be used for a variety of applications such as navigation, finding points of interest (such as restaurants, museums, shopping centers, airports or any other location which may be of interest to the user), serving targeted advertisements to the user or any other application which may require GIS information.

The devices typically use maps for GIS based applications, which have been downloaded onto the device, with various locations (the locations may be places of interest to the user, general places of interest and so on) overlaid on the maps. The user may then use the maps present on the device, depending on his requirements. However, the GIS applications are typically standalone applications, with each of the GIS applications requiring their own maps and interfaces.

Also, current GIS systems are loaded with preconfigured “static” data and there are no personalized suggestions or recommendations for the users. Most of the users rely on static data provided by its GPS or WI devices, to find the direct Point of Interest (POI) user need to find the information from the web and do manual analysis to find the right places, at times people may have to contact friends or family to recommend POI which will be most suitable. Also, none of the GIS systems consider the location and speed of the user to provide recommendations.

### SUMMARY

Accordingly the embodiment provides a method for providing at least one recommendation to a user device of a user, wherein the recommendations are based on at least one of location of the user, the speed at which the user is driving, at least one gesture from the user and activity on at least one social network, the method comprising of fetching data from the user device by a GIS (Geographic Information System) server, wherein the data comprises of location of the user; speed of travel of the user; and at least one gesture of the user;

perform predictive analysis by the GIS server based on the fetched data; and activity on the at least one social network, wherein the activity comprises of activity of the user on at least one social network, activity of social circle of the user on at least one social network; activity of at least one user with a profile similar to the user on at least one social network; and activity of at least one user in vicinity of the user on at least one social network; perform data scoring by the GIS server on the predicted analysis; predict propensity of the user to act in furtherance of the at least one recommendation by the GIS server; and provide at least one recommendation to the user by the GIS server based on the predicted propensity of the user to act in furtherance of the at least one recommendation.

Also, disclosed herein is a system comprising of a GIS (Geographic Information System) server, wherein said GIS server is configured for providing at least one recommendation to a user device of a user, wherein the recommendations are based on at least one of location of the user, the speed at which the user is driving, at least one gesture from the user and activity on at least one social network, the GIS server configured to fetch data from the user device, wherein the data comprises of location of the user; speed of travel of the user; and at least one gesture of the user; perform predictive analysis based on the fetched data; and activity on the at least one social network, wherein the activity comprises of activity of the user on at least one social network, activity of social circle of the user on at least one social network; activity of at least one user with a profile similar to the user on at least one social network; and activity of at least one user in vicinity of the user on at least one social network; perform data scoring on the predicted analysis; predict propensity of the user to act in furtherance of the at least one recommendation; and provide at least one recommendation to the user based on the predicted propensity of the user to act in furtherance of the at least one recommendation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

These embodiments herein are illustrated in the accompanying drawings, through out which like reference letters indicate corresponding parts in the various figures. The embodiments herein will be better understood from the following description with reference to the drawings, in which:

FIG. 1 depicts a system providing GIS (Geographic Information System) services to a user device, according to embodiments as disclosed herein;

FIG. 2 depicts a GIS server, according to embodiments as disclosed herein; and

FIG. 3 is a flowchart illustrating the process of providing a recommendation to a user, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

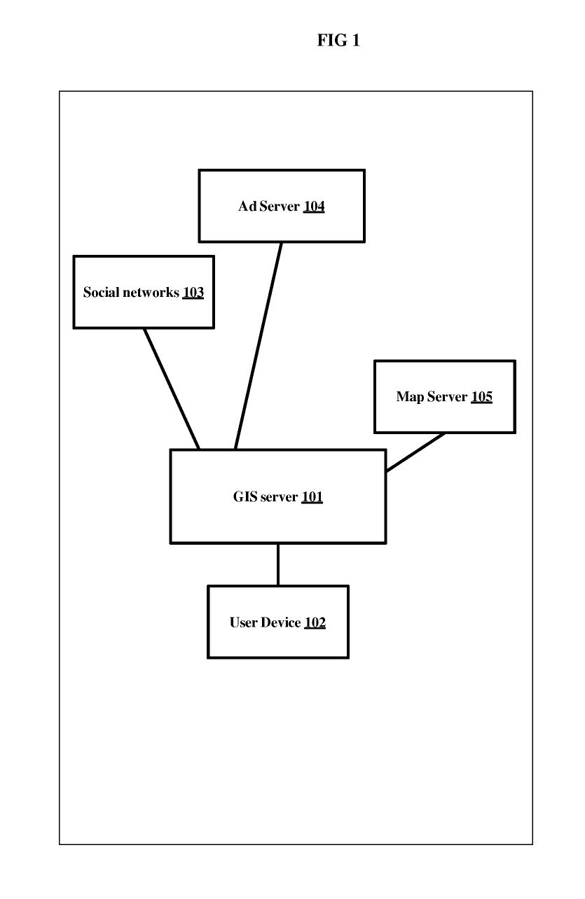

The embodiments herein provide dynamic and personalized recommendations to a user, when the user is driving; wherein the recommendations are based on at least one of social data, predictive analytics, vehicle location and vehicle speed. Referring now to the drawings, and more particularly to FIGS. 1 through 3, where similar reference characters denote corresponding features consistently throughout the figures, there are shown preferred embodiments.

FIG. 1 depicts a system providing GIS (Geographic Information System) services to a user device, according to embodiments as disclosed herein. The system comprises of a GIS server 101 connected to at least one user device 102. The user device 101 may be a portable device used by the user to access GIS services to a user such as a cellular phone, a tablet, a laptop, a dedicated device such as an in-car navigation device or any other device which may be used by a user for accessing GIS services in a vehicle (such as a car, truck, van, boat, ship, cycle and so on). The user device 102 may comprise of a plurality of devices, which may be connected to each other using a suitable connection means such as Bluetooth, Wi-Fi Direct, NFC, ZigBee and so on; wherein the user may use the plurality of devices in a combined manner to access GIS services. The user device 102 may comprise of an app, wherein the app provides user information to the GIS server 101. The user information may comprise of location of the user, the speed at which the user is travelling, his actions performed using the user device 102 (such as making a call, sending a SMS (Short Messaging Service), sending an Instant Message (IM) to another user, his social network updates, social network updates from his social network and so on), images of the user (say, on providing a recommendation to the user), a video feed of the user (which may be continuous or for a pre-defined interval after providing a recommendation to the user) and so on.

The GIS server 101 may be connected to at least one source of data, such as at least one social network 103, at least one ad server 104 and at least one map server 105. The social network 103 may be at least one of an online social network such as Facebook, Instagram, Twitter, Four Square, Pinterest and so on. The ad server 104 may comprise of at least one advertisement, which may be served to a user using the user device 102. The advertisement may one or more of audio, video, text and images. The map server 105 may be a map service provider such as Google Maps, Waze, Nokia Maps, Microsoft Bing, Yahoo Maps, MapQuest, OpenStreetMap, MapMyIndia and so on. The user may select at least one map service provider.

The GIS server 101 provides recommendations to the user in real time, based on gestures of the driver, the location of the user, the speed at which the user is travelling, social data analytics, predictive analytics and so on. The recommendations may be in the form of at least one of advertisements and Places of Interest (PoI) to the user. Gesture as used herein refers to the body language of the user, which may comprise of facial expressions, lips, movement of the arms/fingers, shoulders and so on, which may be used to determine the mood and reaction of the user to a provided recommendation.

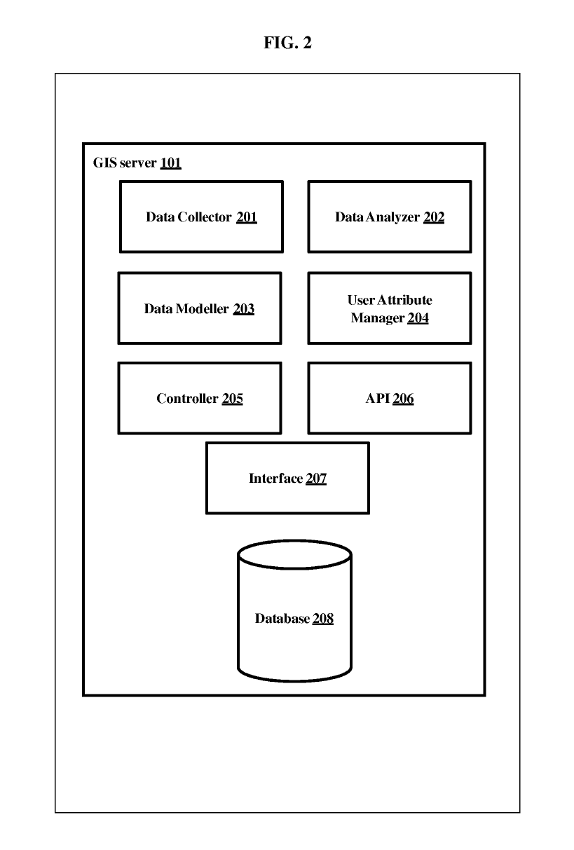

FIG. 2 depicts a GIS server, according to embodiments as disclosed herein. The GIS server 101, as depicted, comprises of a data collector 201, a data analyzer 202, a data modeler 203, a user attribute manager 204, a controller 205, at least one API (Application Programming Interface) 206, at least one pluggable interface 207 and a database 208. In an embodiment herein, the GIS server 101 may be implemented in a cloud. The API 206 enables an external entity to connect to the GIS server 101. The external entity may be at least one of a third party, an advertiser and so on. The API 206 may enable the external entity to add/delete/modify content and at least one criterion associated with content being served to users. The interface 207 may enable at least one of software or hardware to be integrated with the GIS server 101, so as to enable the GIS server 101 to operate with at least one external device or platform. The database 208 comprises of information related to the user such as demographic details, social activities, driving history, purchases/visits based on recommendations provided by the GIS server 101, POI visits based on recommendations from the GIS server 101, the gestures in response to a recommendation provided by the GIS server 101 and so on.

The controller 205 is configured to connect with the user device 102 and authenticate the user. The controller 205 may use a suitable means such as a user name and password for authentication. The controller 205 may also use biometric means such as fingerprint scanner, palm scanner, facial recognition and so on for authentication. The controller 205 may also check if the GIS server 101 has the rights to access a specific resource on the user device 102, before accessing the resource. The controller 205 may also obtain the requisite permissions from the user for accessing other resources on the user device 102. The controller 206 may request the permission from the user once; for example, at the installation of the app, the first time the user is accessing the app and so on. The controller 205 may also request the permission from the user on a case by case basis.

The user attribute manager 204 is configured to fetch data regarding the user from the user device 102, such as the current location of the user, the current speed at which the user is travelling and so on. The user attribute manager 204 may also fetch information from the user device 102, such as the current gestures of the user and so on. The user attribute manager 204 may store the information from the user device in the database 208.

The controller 205 may be further configured to perform gesture recognition on the information received from the user device 102. The controller 205 may attempt to judge the response of the user to a recommendation provided by the GIS server 101 based on the gesture. The controller 205 may also attempt to judge the current mood of the user based on his current gesture, before providing recommendations to the user.

The data collector 201 is configured to connect to at least one social network 103 and fetch data. The data collector 201 may fetch data from the social network profiles of the user, the social network profiles of his social circles, the activities of the user on the social network, the activities of members of his social circles, activities of users with a profile similar to the user on social networks; and activities of the users in vicinity of the user on social networks and so on. The data collector 201 may also fetch data from users who may be in the vicinity of the user and/or may have similar social network profiles to the user (wherein the similarity may be in terms of the social network profiles of the user, the social network profiles of his social circles, the activities of the user on the social network, the activities of members of his social circles and so on). The data collector 201 may also fetch data from other third party data providers.

The data analyzer 202 performs predictive analysis on the data provided by the data collector 201, based on the information present in the database 208 and the information provided by the user attribute manager 204. The data analyzer 202 further performs data scoring based on the predictive analysis and the recommendations which may be made available to the user to predict recommendations which may have a high propensity for being acted upon by the user.

The data modeler 203, based on the analysis and scoring performed by the data analyzer 202, uses at least one suitable data model to predict the propensity of the user to act in furtherance of a provided recommendation. Examples of the act of the user may be purchasing a product based on an advertisement provided to the user, the user stopping at a PoI recommended to the user and so on. The data modeler 203 may also use the past history of the user for predicting the propensity of the user to act in furtherance of a recommendation. The data modeler 203 may use further information such as the current time and so on for predicting the propensity of the user to act in furtherance of a recommendation.

Based on the analysis, the controller 205 provides a recommendation to the user using the user device 102.

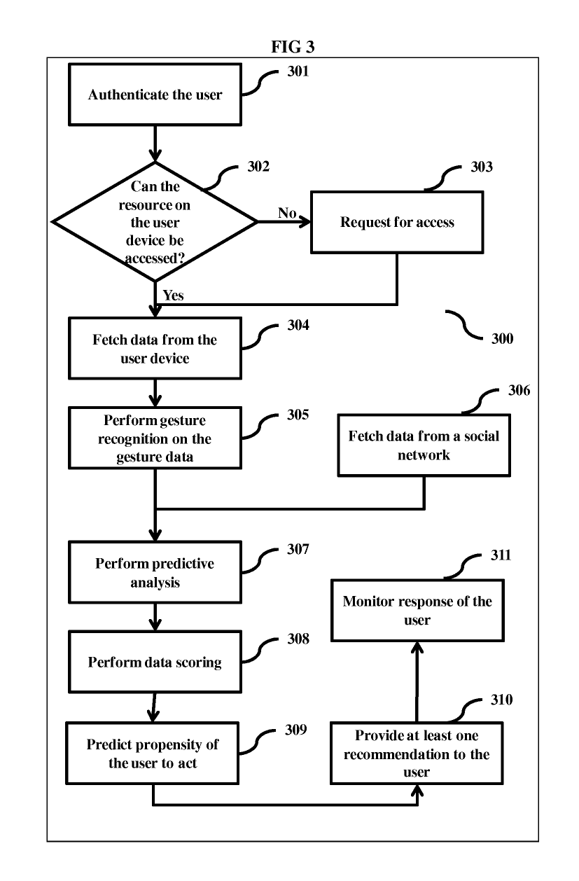

FIG. 3 is a flowchart illustrating the process of providing a recommendation to a user, according to embodiments as disclosed herein. The GIS server 101 connects with the user device 102 and authenticates (301) the user. The GIS server 101 may use a suitable means such as a user name and password for authentication. The GIS server 101 may also use biometric means such as fingerprint scanner, palm scanner, facial recognition and so on for authentication. The GIS server 101 checks (302) if the GIS server 101 has the rights to access a specific resource on the user device 102, before accessing the resource. If the GIS server 101 does not have the rights to access the resource on the user device 102, the GIS server 101 requests (303) the requisite permissions from the user for accessing the resource. If the GIS server 101 has the rights to access the resource on the user device 102, the GIS server 101 fetches (304) data regarding the user from the user device 102, wherein the data comprises of the current location of the user, the current speed at which the user is travelling, the current gestures of the user and so on. The GIS server 101 performs (305) gesture recognition on the information received from the user device 102. The GIS server 101 attempts to judge the response of the user to a recommendation provided by the GIS server 101 based on the gesture. The GIS server 101 also attempts to judge the current mood of the user based on his current gesture, before providing recommendations to the user.

In parallel, the GIS server 101 fetches (306) data from at least one social network 103. The GIS server 101 fetches data from the social network profiles of the user, the social network profiles of his social circles, the activities of the user on the social network, the activities of members of his social circles, activities of users with a profile similar to the user on social networks; and activities of the users in vicinity of the user on social networks and so on. The GIS server 101 also fetches data from users who may be in the vicinity of the user and/or may have similar social network profiles to the user (wherein the similarity may be in terms of the social network profiles of the user, the social network profiles of his social circles, the activities of the user on the social network, the activities of members of his social circles and so on). The GIS server 101 also fetches data from other third party data providers. The GIS server 101 performs (307) predictive analysis on the fetched data, based on the information present in the database 208 and the information received from the user. The GIS server 101 further performs (308) data scoring based on the predictive analysis and the recommendations which may be made available to the user to predict recommendations which may have a high propensity for being acted upon by the user. The GIS server 101, based on the analysis and scoring, predicts (309) the propensity of the user to act in furtherance of a provided recommendation using data models. Examples of the act of the user may be purchasing a product based on an advertisement provided to the user, the user stopping at a PoI recommended to the user and so on. The GIS server 101 may also use the past history of the user for predicting the propensity of the user to act in furtherance of a recommendation. The GIS server 101 may use further information such as the current time and so on for predicting the propensity of the user to act in furtherance of a recommendation. Based on the analysis, the GIS server 101 provides (310) at least one recommendation to the user using the user device 102. Also, the GIS server 101 monitors (311) the response of the user to the recommendation. The various actions in method 300 may be performed in the order presented, in a different order or simultaneously. Further, in some embodiments, some actions listed in FIG. 3 may be omitted.

Consider a car driver who is driving around lunch time on a road. The GIS server 101 detects the location of the car driver, his speed of travel and the time of day (around lunch time), provides a recommendation to the car driver for a restaurant to stop for lunch, which the car driver will reach in the next 15 minutes (considering the current speed and location of the car driver). The GIS server 101 may also provide the contact details of the restaurant, such as the address and phone number, if the car driver wishes to contact the restaurant.

Consider a driver who is driving in the night on a highway, located between two cities. The GIS server 101 detects the location of the car, his speed of travel and the time of day (night, in this case) and constant yawning from the driver. The GIS server 101 provides a recommendation to the driver of at least one hotel located in his vicinity, where he may take a room and sleep for the night. The GIS server 101 may recommend the hotels based on the hotels this driver has stayed in the past, the hotels his social circle use and so on. If the driver and his social circle have a history of staying in only four/five star hotels and positive reviews provided by the driver and/or his social circles, the GIS server 101 may recommend only four/five star hotels in the vicinity, while filtering out the cheaper options. The GIS server 101 may also provide the contact details of the hotel, such as the address and phone number, if the driver wishes to contact the hotel.

Consider a driver with a co-passenger driving in a city in a shopping area. The GIS server 101 detects that driver and/or co-passenger is looking at the various stores. The GIS server 101 checks the history of the driver, co-passenger and their social circles to see which stores they have browsed in the social network, they have visited and so on. Based on this information, the location of the driver and their speed, the GIS server 101 provides a recommendation of at least one store, which is located in front of the driver. The recommendation may be in the form of an advertisement of the stores or a mere listing of the stores. The GIS server 101 may sort the stores in terms of their distance, the predicted propensity of the driver and/or co-passenger to stop there and so on.

Consider a driver who is driving in a city. The GIS server 101 detects the location of the driver, the speed at which he is travelling and so on. The GIS server 101 also detects that his social network activity is directed towards living a healthy life in terms of eating healthy, exercising and so on. The GIS server 101 checks for health clubs, gyms and eating locations/stores which serve health food in the vicinity of the driver and send the recommendations to him. The GIS server 101 may send the recommendations in the form of advertisements and/or a listing.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for providing at least one recommendation to a user device of a user, wherein the recommendations are based on at least one of location of the user, the speed at which the user is driving, at least one gesture from the user and activity on at least one social network, the method comprising of
fetching data from the user device by a GIS (Geographic Information System) server, wherein the data comprises of location of the user; speed of travel of the user; and at least one gesture of the user;
perform predictive analysis by the GIS server based on the fetched data; and activity on the at least one social network, wherein the activity comprises of activity of the user on at least one social network, activity of social circle of the user on at least one social network; activity of at least one user with a profile similar to the user on at least one social network; and activity of at least one user in vicinity of the user on at least one social network;
perform data scoring by the GIS server on the predicted analysis;
predict propensity of the user to act in furtherance of the at least one recommendation by the GIS server; and
provide at least one recommendation to the user by the GIS server based on the predicted propensity of the user to act in furtherance of the at least one recommendation.

2. The method, as claimed in claim 1, wherein the at least one recommendation is at least one of at least one of an advertisement; and at least one Point of Interest (PoI).

3. The method, as claimed in claim 1, wherein the method further comprises of authenticating the user by the GIS server, before providing the at least one recommendation to the user.

4. The method, as claimed in claim 1, wherein the method further comprises of monitoring a response to the at least one recommendation from the user by the GIS user.

5. A system comprising of a GIS (Geographic Information System) server, wherein said GIS server is configured for providing at least one recommendation to a user device of a user, wherein the recommendations are based on at least one of location of the user, the speed at which the user is driving, at least one gesture from the user and activity on at least one social network, the GIS server configured to
fetch data from the user device, wherein the data comprises of location of the user; speed of travel of the user; and at least one gesture of the user;
perform predictive analysis based on the fetched data; and activity on the at least one social network, wherein the activity comprises of activity of the user on at least one social network, activity of social circle of the user on at least one social network; activity of at least one user with a profile similar to the user on at least one social network; and activity of at least one user in vicinity of the user on at least one social network;
perform data scoring on the predicted analysis;
predict propensity of the user to act in furtherance of the at least one recommendation; and
provide at least one recommendation to the user based on the predicted propensity of the user to act in furtherance of the at least one recommendation.

6. The system, as claimed in claim 5, wherein the at least one recommendation is at least one of at least one of an advertisement; and at least one Point of Interest (PoI).

7. The system, as claimed in claim 5, wherein the GIS server is further configured for authenticating the user, before providing the at least one recommendation to the user.

8. The system, as claimed in claim 5, wherein the GIS server is further configured for monitoring a response to the at least one recommendation from the user by the GIS user.
